(19) United States
(12) Patent Application Publication
(10) Pub. No.: US 2024/0199345 A1
(43) Pub. Date: Jun. 20, 2024

(54) Rotating Singulator

(71) Applicant: Thomas Largent, Redding, CA (US)

(72) Inventor: Thomas Largent, Redding, CA (US)

(21) Appl. No.: 18/081,275

(22) Filed: Dec. 14, 2022

(51) Int. Cl. B65G 47/14; B65G 47/84

(52) U.S. Cl. CPC B65G 47/1478; B65G 47/846; B65G 2201/0273

(57) ABSTRACT

A system and method are disclosed for the transporting and separating of tires. The system and method use a rotating singulator that receives a plurality of tires into a feed hopper. The singulator retrieves the tires from the hopper and separates them so that a single tire is positioned between the rotating spokes of the singulator. The tires are lifted by the spokes to a feed tray and pivoted onto their side and laid flat onto the feed tray and conveyor for further processing.

### FIELD OF THE INVENTION

The present invention generally relates to an apparatus and method for transporting and separating tires. More particularly, the present invention relates to a rotating singulator configured to receive, separate, orient, and transport tires.

### SUMMARY OF THE INVENTION

The present invention is directed to a singulator comprising a circular frame, a disk, a hub, and a plurality of spokes supported by the hub. The disk is supported within the frame having an opening. The hub is supported at the center of the frame. The plurality of spokes are supported by the hub for rotation within the frame to place a tire at the opening. There is a tire separator supported by the frame and configured to position one tire between each of the plurality of spokes. There is a means for guiding the tire through the opening in the disk. The means is positioned at the opening and supported by the disk.

The present invention is further directed to a system for transporting and separating tires. The system comprises a feed system, a singulator, a transport member, and a conveyor. The singulator comprises a circular frame, a disk, a hub, a plurality of spokes, a tire separator, and an exit plate. The disk is supported within the frame and comprises an opening. The hub is supported at the center of the frame. The plurality of spokes are supported by the hub for rotation within the frame to place a tire at the opening. There is a means for guiding the tire through the opening in the disk. It is positioned at the opening and supported by the disk. The tire separator is supported by the frame and configured to position a single tire between two of the plurality of spokes. The exit plate is supported by the disk and positioned at the opening of the disk to receive the tire from the opening. The transport member moves the tire from the exit plate to a conveyor operatively connected to the transport member to receive the tire.

The present invention is further directed to a method for transporting and separating tires. The method comprises feeding a plurality of tires into a hopper. A plurality of spokes are rotated within a circular frame to place an edge of a single tire against one of the plurality of spokes and against a disk connected to the frame. A tire is lifted with a spoke to an opening formed in the disk. The tire is pivoted on its edge to lay the tire flat on an exit plate. The tire is slid along the exit plate to a conveyor.

### BRIEF DESCRIPTION OF THE DRAWINGS

FIG. 1 is a plan view of the singulator and transport system of the present invention.

FIG. 2 is a front view of the singulator of the invention.

FIG. 3 is a side view of the singulator.

FIG. 4 is a side view of the singulator of FIG. 3 pivoted upward to ninety (90) degrees relative to the ground.

FIG. 5 is a side view of FIG. 4 having the hub and spokes of the singulator removed.

FIG. 6 is an opposing view of the singulator shown in FIG. 5.

FIG. 7 is a back view of the singulator shown in FIG. 5.

FIG. 8 is a partially exploded view of the feed plate assembly of the present invention.

FIG. 9 is a front view of the hub and spoke assembly of the singulator.

FIG. 10 is a side view of the hub and spoke assembly shown in FIG. 9.

FIG. 11 is a front view of the hub and spoke assembly having a plurality of tires.

FIG. 12 shows a tire's path of travel from the singulator of the present invention.

FIG. 13 is a front view of the singulator assembly showing the opening through which the tires are transported and the tire separator assembly supported on the frame.

FIG. 14 is a zoomed-in view of the tire separator shown in FIG. 13 along line 13-13.

### DESCRIPTION OF THE INVENTION

For a number of years, industries, such as the cement industry, have been using old or waste tires as fuel. Generally, the tires would be transported to the user's site and stored in bins. Present separation and transporting systems receive tires from the user's tire bin and provide an inclined linear conveyor. Many systems for separating and transporting tires require manual handling or placement of the tires on the conveyor in a single file. Systems like the one disclosed in U.S. Pat. No. 5,806,654 issued to Thomas R. Largent, address this issue and provide a way of placing tires on a conveyor with minimal manual handling of the tires. However, there remains a need for new singulator systems for the efficient handling and transport of tires.

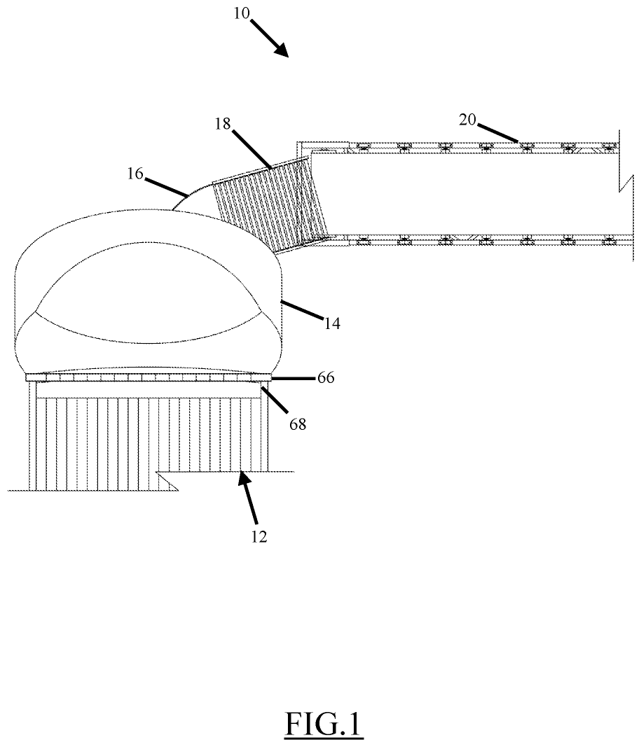

Turning now to the figures. FIG. 1 illustrates a system 10 for transporting and separating tires. System 10 comprises a feed system 12, a singulator 14, an exit plate 16, a transport assembly 18, and a conveyor 20. The feed system 12 may comprise a feed hopper such as a walking floor or pan conveyor configured to move a plurality of tires from the feed system to the singulator 14.

Tires are unloaded from a truck onto the feed hopper 12. The feed hopper moves the tires to the singulator 14 where they are separated and placed one by one on the exit plate 16. The tires are placed on the exit plate 16 on their sides. The tires move down along the transport assembly 18. The transport assembly 18 may comprise gravity rollers configured to transport the tires from the exit plate 18 to flat belt conveyor 20. The conveyor 20 then transports the tires one by one to a tire shredder, cement kiln, or other recycling processes.

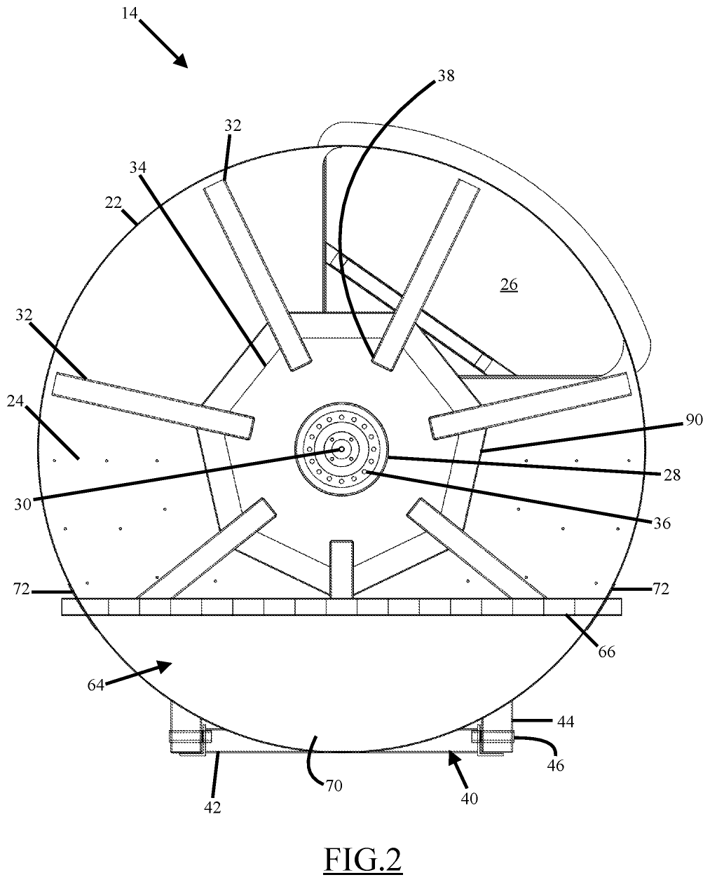

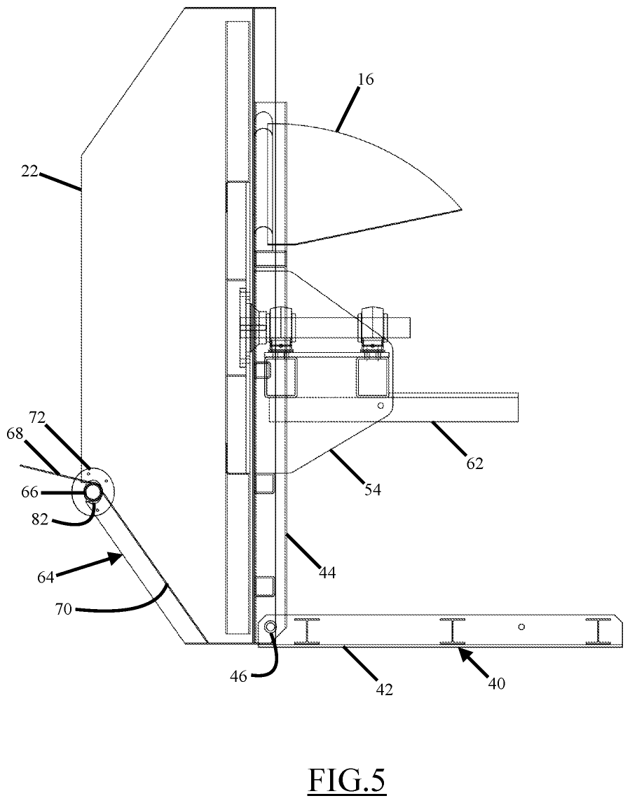

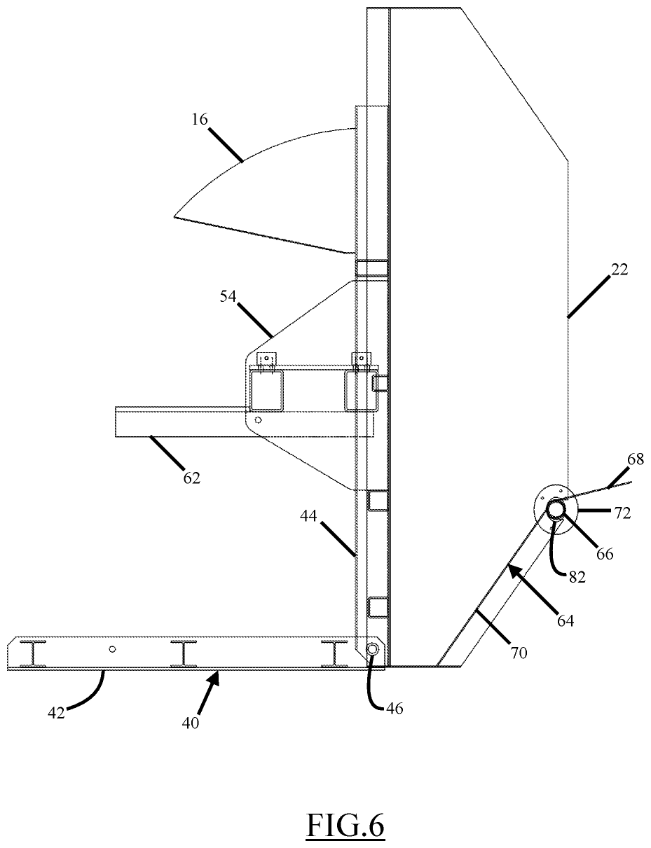

Turning now to FIGS. 2-7, the singulator 14 of the present invention is shown. The singulator comprises a circular frame 22 disposed about the periphery of the singulator. A disk 24 is supported within the frame and has an opening 26 formed in the disk's upper right quadrant. A hub 28 is supported at the center point 30 of frame 22. A plurality of spokes 32 are supported by hub 28 for rotation within frame 22 to place a tire at opening 26. Each of the plurality of spokes 32 is affixed to a base plate 34 and extends radially from the center point 30. In the embodiment shown in FIG. 2, the base plate 34 has seven (7) sides and is affixed to hub 28 using a plurality of fasteners 36. The base plate 34 has a plurality of notches 38 about its periphery. The notches 38 are sized and configured to support the spokes 32 so that the distal end of each spoke is supported near, but not touching, frame 22 as the spokes are rotated with the base plate 34 and the hub 28.

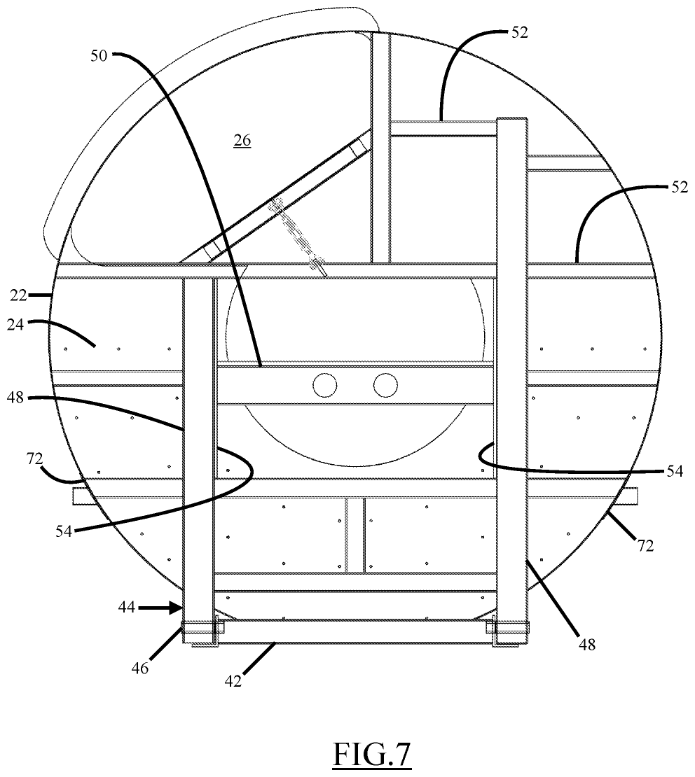

Frame 22 is supported on a pivotal support frame 40 comprising a movable skid. The pivotal support frame 40 has a base assembly 42 and a frame assembly 44. The base assembly 42 engages the ground and supports the frame assembly 44 at a pivot 46. The base assembly 42 may comprise a plurality of steel support members and cross beams secured to each other. As shown in FIG. 7, the frame assembly may comprise a pair of beams 48 spaced apart laterally from each other. A wheel mount 50 is disposed between beams 48 and positioned to support hub 28 at the center point 30 of frame 22. A plurality of support beam members 52 are affixed to beams 48 and form a support structure for disk 24.

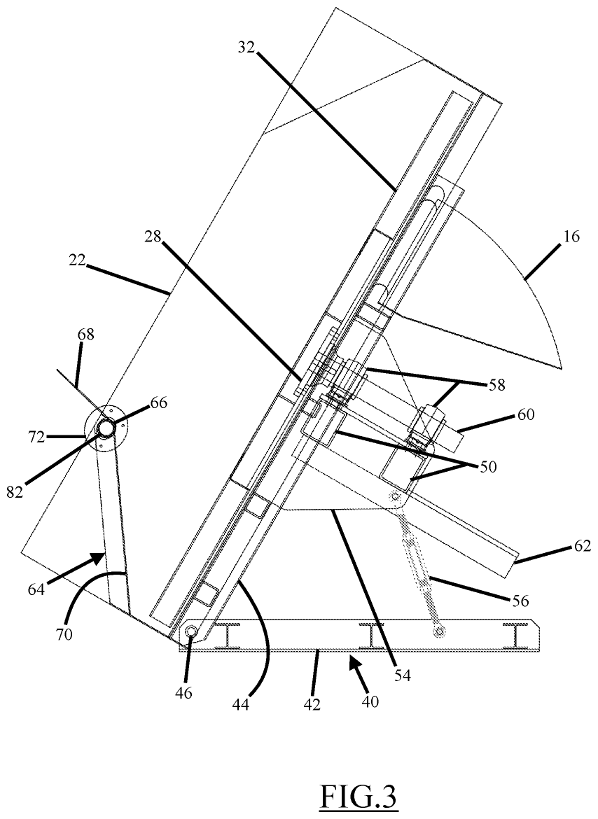

A pair of wheel mount assemblies 54 are supported by beams 48 and extend outward. An adjustable support 56 comprising a turnbuckle is connected between the wheel mount assembly 54 and the base assembly 42. The turnbuckle 56 permits the singulator 14 to pivot relative to the pivotal support frame 40 in operation, the singulator 14 is set at an angle less than ninety (90) degrees as shown in FIG. 3. The turnbuckle 56 permits pivotal adjustment of the singulator to encourage tires within the singulator to lay on their side against the disk 24.

The wheel mount 50 may have two steel square tube members welded to the wheel mount subassembly 54. Bearing assemblies 58 are affixed to the wheel mount 50 and arranged linearly to support shaft 60 of the hub assembly 28 for rotation within the bearing assemblies. A motor mount 62 is connected to the wheel mount 50 and configured to support a motor 63 or other motive force generator to drive rotation of the shaft 60. The motor 63 may comprise an electric or combustion motor used to drive rotation of the shaft 60,

Referring now to FIGS. 2 through 6 and FIG. 8, there is an adjustable feed plate assembly 64 that receives tires from the feed hopper 12. The feed plate assembly 64 comprises a hinge pipe plate mount 66, a feeder transition plate 68, a feed plate 70, and retainer brackets 72. The feed plate assembly is supported by the frame 22 in front of hub 28 and spokes 32 and is designed to hold a plurality of tires within the singulator 14. The hinge pipe plate mount 66 is shown in a horizontal orientation and forming a chord across the circle defined by frame 22.

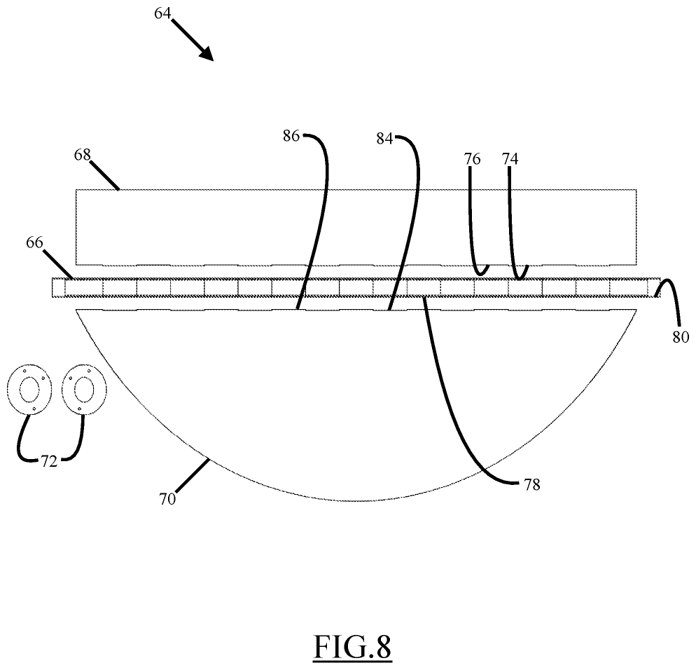

As shown in FIG. 1, the feeder transition plate 68 abuts or overlaps the feed hopper 12 and is affixed to the hinge pipe plate mount 66. As shown in FIG. 8, one edge of the feeder transition plate 68 comprises a series of tabs 74 and notches 76. The tabs 74 are spaced to correspond to every other segment 78 of the hinge pipe plate mount 66.

The hinge pipe plate mount 66 is supported in notches 82 formed on frame 22 and held in place by retainer brackets 72. The retainer brackets 72 are fastened to frame 22 and positioned so that segments 78 (described hereinafter) of the hinge pipe plate mount 66 may rotate about its long axis.

Hinge pipe plate mount 66 comprises the plurality of pipe segments 78 that are supported on an elongated inner member 80 so that the segments are able to rotate about the inner member 80. The feeder transition plate 68 welded to every other segment 78, so the feeder transition plate is rotatable to adjust to the height and angle of the feed hopper 12.

The feed plate 70 has an arcuate profile formed to match the circular profile of frame 22. The feed plate 70 is attached to frame 22 just below the hinge pipe plate mount 66. The non-arched edge of the feed plate 70 also comprises a series of notches 84 and tabs 86. The tabs are positioned to be attached to alternating segments 78 of the hinge pipe plate mount 66. The feed plate 70 is attached to the segments that are not attached to the feeder transition plate 68. In this way, the feeder transition plate 68 is capable of movement relative to the feed plate 70 to adjust the height and angle of the feed hopper.

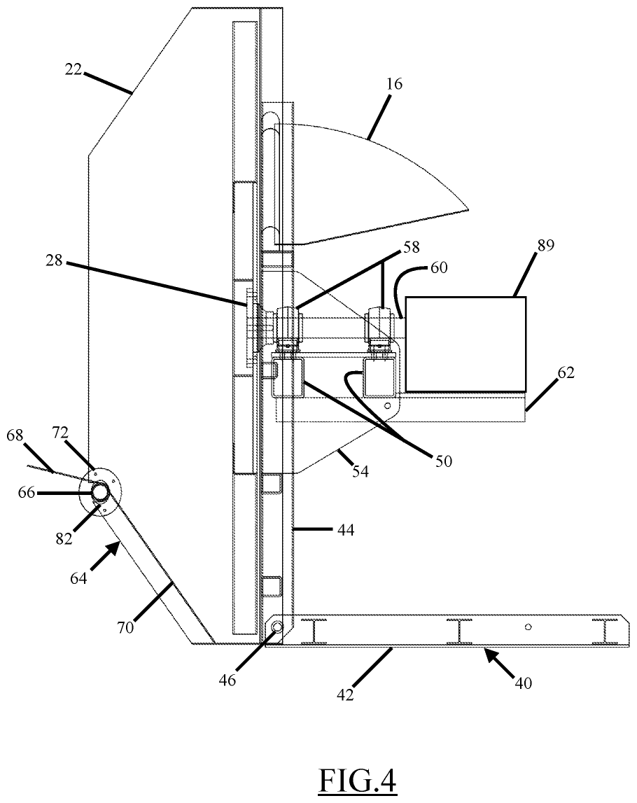

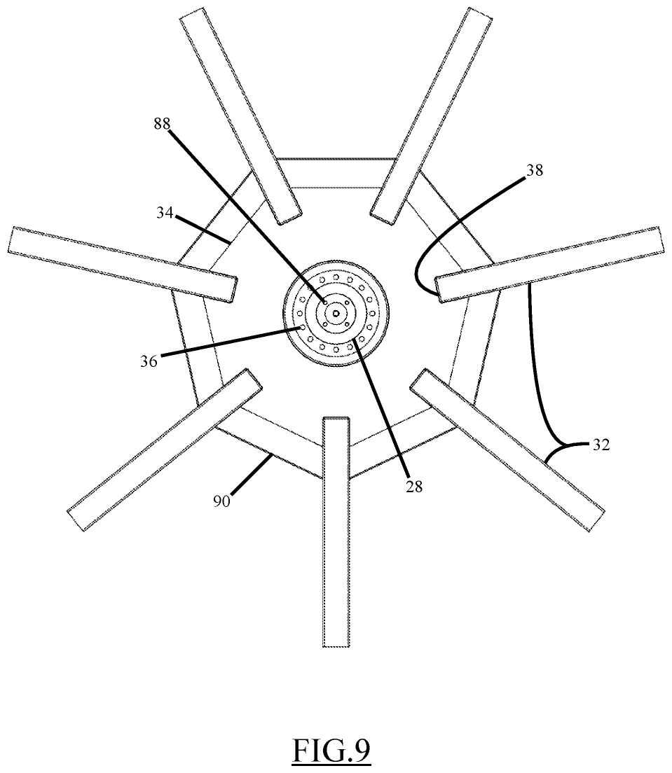

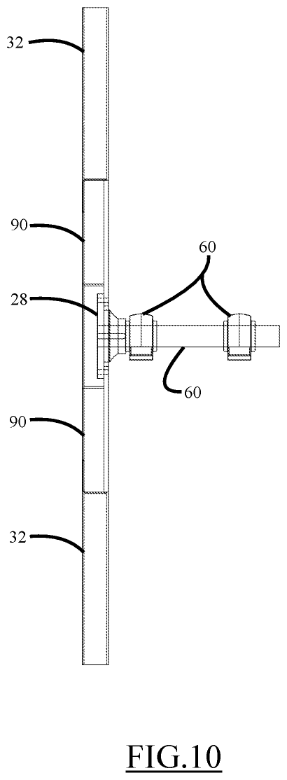

With reference now to FIGS. 9 and 10 the hub 28 and spoke assembly is shown in greater detail. Hub 28 is operatively connected to shaft 60 by fasteners 88 and is supported by bearings 58. The shaft 60 is operatively connected to motor 89 (FIG. 4) to apply motive force to the shaft. Hub 28 is operatively connected to base plate 34 using fasteners 36. In the embodiment shown in FIG. 9, base plate 34 comprises a heptagon with notches 38 formed at each vertice. The spokes 32 are positioned within each notch 38 and affixed to the base plate. A plurality of support braces 90 extend between the spokes 32 and provide additional support for the spokes and base plate 34. The support braces 90 are mounted to the base plate 34 and span between adjacent spokes 32 to provide rigidity to the spokes during operation and lifting of tires.

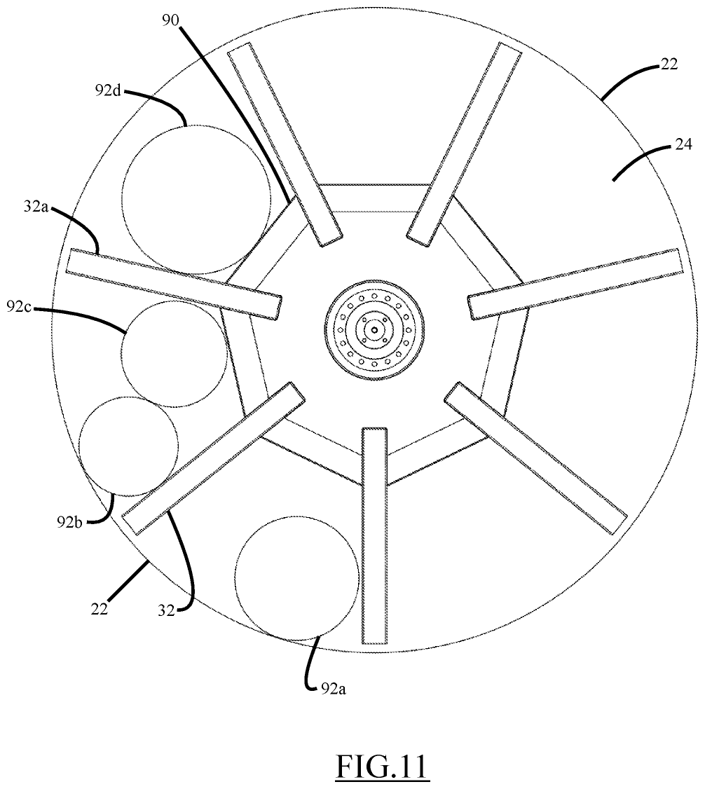

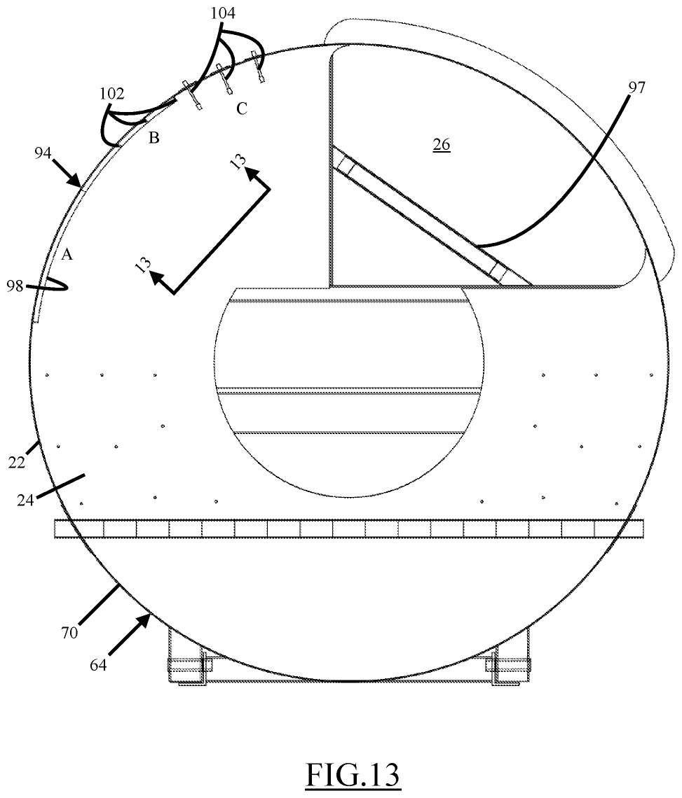

As shown in FIG. 11, the spokes 32 are sized and positioned for the placement of preferably a single tire 92 between a pair of spokes. In operation, tires 92 are transported into singulator 14 and come to rest between the feed plate 70 and disk 24. The singulator 14 operates to separate the multiple tires so the tires exit the singulator one at a time. Accordingly, the spokes 32 work in conjunction with a tire separator 94 (FIG. 13) and tire guide 96 to separate tires and place them on their side one by one on the exit plate 16.

The spokes 32 are rotated clockwise to move tires 92 upward toward the top of disk 24 and towards the opening 26 (FIG. 2). In the event two or more tires 92 are disposed between two spokes 32, as shown with tires 92b and 92c, a tire separator 94 (FIG. 13) is used to remove the tire in the position of tire 92b from between the spokes 32. As the spokes 32 rotate to move the tires above the horizontal radius of disk 24, tire 92d rolls to rest against the lower spoke 32a and one of the plurality of support braces 90, as illustrated by tire 92d.

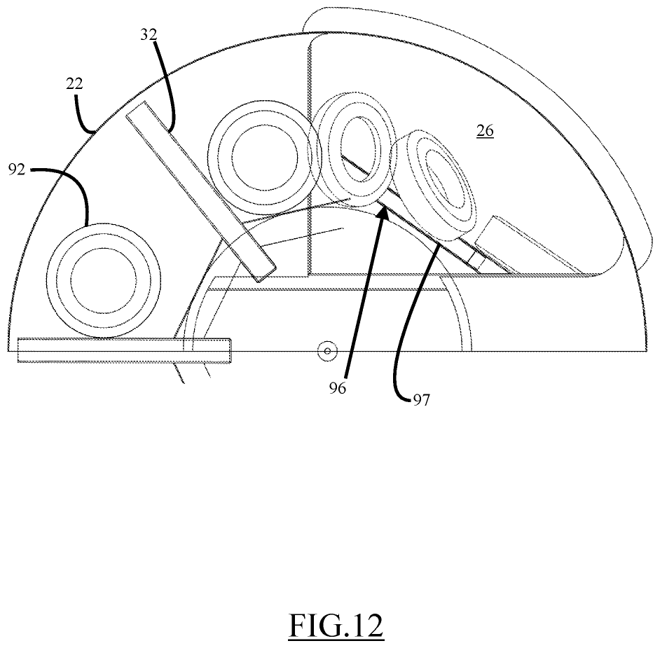

FIG. 12 shows the progression of tire 92 as it is lifted and moved to opening 26. Tire 92 is positioned between spokes 32 and moved toward opening 26 as the spokes 32 rotate clockwise. The singulator has a tire guide 96 configured to guide the tire through the opening 26 in the disk 24. The tire guide 96 forms the lower boundary of the opening 26 and is oriented at an angle of less than ninety (90) degrees to the horizontal radius of disk 24. In the embodiment shown in FIG. 12, the tire guide 96 is an elongated cylindrical member 97 connected to the disk 24 along the cylindrical member's length. The tire guide 96 is positioned and configured to roll the tire from the tire's edge to laying flat on its side on the exit plate 16. The spoke 32 rotates clockwise to push the tire towards the opening 26. Because the singulator is oriented at an angle less than ninety (90) degrees (FIG. 3) relative to horizontal the tires edge or tread is positioned against the spoke 32 and its side lies against the disk 24. Once tire 92 reaches opening 26 the tire rotates over tire guide 97 so that it lies flat on the exit plate 16 and is fed onto the gravity rollers 18 (FIG. 1). Accordingly, the tires are placed into the feed hopper and separated by the singulator and placed one-by-one onto the exit plate 16 without the need for manual handling of the tires.

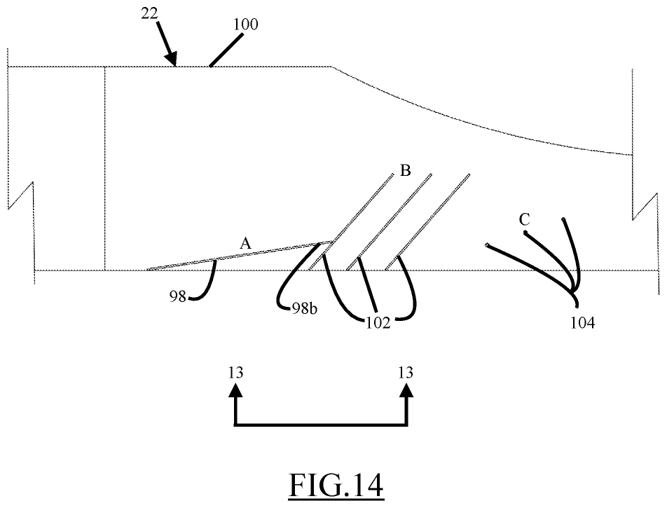

Referring now to FIGS. 13 and 14, the tire separator 94 of the present invention is shown. FIG. 14 shows a cut-away view of the tire separator along line 13-13 of FIG. 13. The tire separator 94 comprises three elements configured to remove a second tire disposed between the spokes 32 before the tires reach opening 26. The first element is a rigid bar 98. The rigid bar 98 is mounted to frame 22 on the inside curve of the frame. The first end of rigid bar 98 is positioned so it abuts disk 24 and projects outward from the disk at an angle of less than forty-five (45) degrees. In the embodiment shown herein, the angle between rigid bar 98 and disk 24 is approximately nine (9) degrees so that the second end of the bar is closer to the front edge 100 of the frame. If the angle is nine (9) degrees, the second end of bar 98 is affixed to frame 22 so that the second end 98b is approximately seven (7) inches from disk 24. Rigid bar 98 has a maximum height from frame 22. In the present embodiment, the maximum height of bar 98 is less than two (2) inches so that spokes 32 may pass by the bar as they rotate within frame 22. In a preferred embodiment, the clearance between spokes 32 and frame 22 is two (2) inches and the height of bar 98 is one inch.

The second element of tire separator 94 is a rod 102 affixed at its first end to frame 22 proximate to disk 24. Rod 102 projects outward toward the edge 100 of frame 22. The rod 102 may be positioned so that the angle formed between rod 102 and disk 24 is less than ninety (90) degrees and preferably approximately forty-five (45) degrees. As shown in FIGS. 13 and 14, there may be a series of three rods 102, all parallel to each other. Like bar 98, the maximum height of rod 102 is less than the gap between the end of spokes 32 and the inside surface of frame 22.

The third element of tire separator 94 is a plurality of brushes 104 mounted through frame 22 and extending into the inside of the frame. The brushes comprise wire rope with brushes on the end. They are positioned in frame 22 to engage the single tire 92 and to brush the tire as it is moved to the opening 26. The wire rope is flexible to bend under the force of the tire passing by without ejecting the tire forward from between the spokes.

If two tires (as shown in FIG. 11) are positioned between spokes 32, tire 92b (FIG. 11) will engage the tire separator 94 to eject tire 92b from between the spokes while permitting tire 92c to stay between the spokes. Tire 92b will engage bar 98. The orientation of bar 98 relative to disk 24 forces tire 92b forward. If bar 98 does not eject tire 92b, rods 102 will engage tire 92b and force the tire from between the spokes. The tire 92c continues moving clockwise until it reaches opening 26 where it is rotated from the disk onto the exit plate 16 (FIG. 1).

In operation, a plurality of tires 92 is fed into the feed plate assembly 64 comprising a hopper. The spokes 32 are rotated within frame 22 to place an edge of a single tire against one of the plurality of spokes and the side of the tire against disk 24. The tire is lifted with a spoke to an opening formed in disk 24. The tire pivots on its edge to pass through opening 26 to lay flat on exit plate 16. The tire is then moved to a gravity conveyor and then to a flat belt conveyor. The flat belt conveyor transports a plurality of single tires laid on their sides to a shredder or kiln for further use or recycling.

Although the present invention has been described with respect to the preferred embodiments, various changes and modifications may be suggested to one skilled in the art, and it is intended that the present invention encompass such changes and modifications as fall within the scope of this disclosure.

What is claimed is:

1. A singulator comprising:
a circular frame;
a circular disk supported by the frame and comprising an opening;
a hub supported at a center of the frame;
a plurality of spokes supported by the hub for rotation within the frame to place a tire at the opening;
a tire separator supported by the frame and configured to position one tire between each of the plurality of spokes; and
a means for guiding the tire through the opening in the disk, positioned at the opening and supported by the disk.

2. The singulator of claim 1 comprising a directional hopper operatively connected to the frame to position the tire between two of the plurality of spokes.

3. The singulator of claim 1 comprising a motor operatively connected to the hub and configured to rotate the hub and the plurality of spokes.

4. The singulator of claim 2 comprising a bracing member operatively connected to the frame to move and support the disk and frame at a plurality of angles equal to or less than ninety degrees to horizontal.

5. The singulator of claim 1 wherein the disk and the plurality of spokes are configured to position an edge of the tire against at least one of the plurality of spokes.

6. The singulator of claim 5 further comprising:
an exit plate supported by the disk and positioned at the opening of the disk; and
the means for guiding the tire through the opening in the disk pivots the tire from the spoke onto the exit plate.

7. The singulator of claim 1 comprising:
a directional hopper operatively connected to the frame to position the tire between two of the plurality of spokes;
a motor operatively connected to the hub to drive rotation of the hub and the plurality of spokes relative to the frame;
a bracing member operatively connected to the frame to move and support the disk and frame at a plurality of angles equal to or less than ninety degrees to horizontal; and
an exit plate supported by the disk and positioned at the opening of the disk to receive the tire from the opening.

8. The singulator of claim 7 wherein the means for guiding the tire through the opening comprises a cylindrical member connected to the disk along its length.

9. The singulator of claim 8 wherein the exit plate is proximate to the cylindrical member.

10. A system for transporting and separating tires comprising:
a feed system;
a singulator comprising:
a circular frame;
a disk supported within the frame and comprising an opening;
a hub supported at a center of the frame;
a plurality of spokes supported by the hub for rotation within the frame to place a tire at the opening;
a means for guiding the tire through the opening in the disk positioned at the opening and supported by the disk;
a tire separator supported by the frame and configured to position one tire between each of the plurality of spokes; and
an exit plate supported by the disk and positioned at the opening of the disk to receive the tire from the opening;
a transport assembly configured to transport the tire from the exit plate; and
a conveyor operatively connected to the transport member to receive the tire.

11. The system of claim 10 comprising a directional hopper operatively connected to the frame to receive a tire from the feed system and configured to position the tire between two of the plurality of spokes.

12. The system of claim 10 comprising a motor operatively connected to the hub and configured to rotate the hub and the plurality of spokes.

13. The system of claim 11 comprising a bracing member operatively connected to the frame to move and support the disk and frame at a plurality of angles equal to or less than ninety degrees to horizontal.

14. The system of claim 10 wherein the disk and the plurality of spokes are configured to position an edge of the tire against at least one of the plurality of spokes.

15. The system of claim 14 wherein the means for guiding the tire through the opening pivots the tire from the spoke onto the exit plate.

16. The system of claim 10 comprising:
a directional hopper operatively connected to the frame to position the tire between two of the plurality of spokes;
a motor operatively connected to the hub to drive rotation of the hub and the plurality of spokes relative to the frame; and
a bracing member operatively connected to the frame to move and support the disk and frame at a plurality of angles equal to or less than ninety degrees to horizontal.

17. The system of claim 16 wherein the means for guiding the tire through the opening comprises a cylindrical member connected to the disk along its length.

18. The system of claim 17 wherein the singulator further comprises a tire separator configured to eject a tire from between adjacent spokes,

19. The system of claim 17 wherein the exit plate is supported on the cylindrical member.

20. A method for transporting and separating tires comprising:
feeding a plurality of tires into a hopper;
rotating a plurality of spokes within a circular frame to place an edge of a single tire against one of the plurality of spokes and against a disk connected to the frame;
lifting a tire with a spoke to an opening formed in the disk;
pivoting the tire on the edge to lay it flat on an exit plate; and
sliding the tire along the exit plate to a conveyor.
